(19) United States
(12) Patent Application Publication
(10) Pub. No.: US 2016/0264816 A1
(43) Pub. Date: Sep. 15, 2016

(54) Polyester Resin for Highly Filled Powder Coating

(71) Applicant: Valspar Sourcing, Inc., Minneapolis, MN (US)

(72) Inventors: George W. O'Dell, Lawson, MO (US); Thomas E Reno, Americus, GA (US)

(73) Assignee: Valspar Sourcing, Inc., Minneapolis, MN (US)

(21) Appl. No.: 15/162,900

(22) Filed: May 24, 2016

Related U.S. Application Data
(63) Continuation of application No. PCT/US2014/067049, filed on Nov. 24, 2014.
(60) Provisional application No. 61/908,451, filed on Nov. 25, 2013.

(51) Int. Cl. C09D 167/02; B05D 3/00

(52) U.S. Cl. CPC C09D 167/02; B05D 3/007; C08K 5/0041

(57) ABSTRACT

Methods and compositions for coating metal substrates with powder coatings are provided. The methods and systems include application of TGIC-reactive carboxyl-functional polyester resins with high acid number and low melt viscosity, used in powder coatings formulated at high pigment loadings, and optionally including a pigment dispersant in the premix prior to extrusion.

### CROSS-REFERENCE TO RELATED APPLICATION(S)

This application is a continuation of International Application No. PCT/US2014/067049, filed 24 Nov. 2014, which claims priority from U.S. Provisional Application No. 61/908,451, filed 25 Nov. 2013, each of which is incorporated herein by reference in its entirety.

### BACKGROUND

Powder coatings are solvent-free, 100% solids coating systems that have been used as low VOC and low cost alternatives to traditional liquid coatings and paints.

Powder coatings typically include one or more pigments. Reduced raw material cost, the ability to achieve reduced gloss when desired, and the potential to increase hiding power at reduced film thickness are all incentives for high pigment loading in powder coating formulations. However, the amount of pigment that can be added tends to be limited. At high pigment loading, the melt viscosity of the composition increases, and the flow and leveling of the powder coating suffer as a consequence. Therefore, conventional powder coatings are typically formulated to contain less than about 40 wt-% pigment, compromising raw material cost and hiding power for a coating with good flow and leveling.

From the foregoing, there is an obvious need for polyester resin-based powder coatings that include a high pigment load, without compromising other coating properties such as leveling, flow, smoothness, gloss and the like.

### SUMMARY

The powder coating compositions described herein include a solid carboxyl-functional polyester resin having an acid number of about 45 to 60 and a melt viscosity less than about 300 poise at 160° C. In addition, the composition also includes one or more pigments at a total loading of at least about 40 wt %, based on the total weight of the composition, along with a triglycidyl isocyanurate (TGIC) curing agent, and, optionally, a pigment dispersant.

In another embodiment, the present description provides methods for making a powder coating composition. The methods include providing a carboxyl-functional polyester resin, a TGIC-based curing agent, one or more pigments at a total pigment load of at least about 40 wt % based on the total weight of the composition, and, optionally, a pigment dispersant. The resin, curing agent, pigment(s) and pigment dispersant are blended to form a premix, followed by extruding the premix and grinding the extrudate to form the powder coating composition.

The details of one or more embodiments and aspects of the invention are set forth below. Other features, objects, and advantages of the invention will be apparent from the description and from the claims.

### SELECTED DEFINITIONS

Unless otherwise specified, the following terms as used herein have the meanings provided below.

The term “on”, when used in the context of a coating applied on a surface or substrate, includes both coatings applied directly or indirectly to the surface or substrate. Thus, for example, a coating applied to a primer layer overlying a substrate constitutes a coating applied on the substrate. Additionally, the term “substrate,” as used herein refers to surfaces that are untreated, unprimed or clean-blasted, and also to surfaces that have been primed or pretreated by various methods known to those of skill in the art, such as electrocoating treatments, for example.

Unless otherwise indicated, the term “polymer” includes both homopolymers and copolymers (i.e., polymers of two or more different monomers). As used herein, the term “(meth)acrylate” includes both acrylic and methacrylic monomers and homopolymers as well as copolymers containing the same.

The term “comprises” and variations thereof do not have a limiting meaning where these terms appear in the description and claims.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, “a,” “an,” “the,” “at least one,” and “one or more” are used interchangeably. Thus, for example, a coating composition that comprises “an” additive can be interpreted to mean that the coating composition includes “one or more” additives.

Also herein, the recitations of numerical ranges by endpoints include all numbers subsumed within that range (e.g., 1 to 5 includes 1, 1.5, 2, 2.75, 3, 3.80, 4, 5, etc.). Furthermore, disclosure of a range includes disclosure of all subranges included within the broader range (e.g., 1 to 5 discloses 1 to 4, 1.5 to 4.5, 1 to 2, etc.).

### DETAILED DESCRIPTION

Embodiments of the invention described herein include compositions and methods for powder coating a substrate. The composition as described herein includes a carboxyl-functional resin and a TGIC curing agent, along with one or more pigments at a total pigment load of at least about 40 wt % based on the total weight of the composition. A pigment dispersant is also included. The method includes steps for providing a carboxyl-functional resin and a TGIC curing agent, along with one or more pigments and a pigment dispersant. These are blended into a premix, followed by steps of extruding and grinding to form a powder coating composition. Articles coated with the composition described herein and methods of making coated articles are also provided herein.

In an embodiment, the powder composition described herein includes a polymeric binder system, including at least one polymeric resin and at least one curing agent. The powder composition also includes pigments, dispersants, opacifying agents, and/or other additives.

Suitable polymeric binders generally include a film forming resin and a curing agent for the resin. The film-forming resin may be selected from any resin or combination of resins that provides the desired film properties. Suitable examples of polymeric resins include amorphous and crystalline thermosetting and/or thermoplastic materials, and can be made with epoxy, polyester, polyurethane, polyamide, acrylic, polyvinylchloride, nylon, fluoropolymer, silicone, other resins, or combinations thereof. Thermoset materials are preferred for use as resins in powder coating applications, and epoxies, polyesters and acrylics are particularly preferred. If desired, elastomeric resins may be used for certain applications. In an aspect, specific polymeric binders or resins are included in the powder compositions described herein depending on the desired end use of the powder-coated substrate. For example, certain high molecular weight polyesters show superior corrosion resistance and are suitable for use on substrates used for interior and exterior applications. Similarly, amorphous polyesters are useful in applications where clarity, color, and chemical resistance are desired.

Powder coatings are sometimes formulated as epoxy-polyester hybrid resin systems. Such systems demonstrate good flow and leveling properties. Without limiting to theory, this is believed to be due to the relatively low melt viscosity of the epoxy component. However, due to the epoxy resin component, these hybrid systems typically do not show optimal exterior weathering or weather resistance. Therefore, in order to achieve satisfactory exterior weathering, the incorporation of epoxy resins, such as bisphenol A-based resins, into polyester-based powder compositions must be avoided.

Accordingly, in an embodiment, the film-forming resin used in the polymeric binder system described herein is a carboxyl-functional resin. Combination of the resin with a curing agent produces the binding system described herein. Examples of suitable binder systems include the following: carboxyl-functional polyester resins, carboxyl-functional polyester resins cured with epoxide-functional compounds (e.g., triglycidyl isocyanurate or TGIC), carboxyl-functional polyester resins cured with polymeric epoxy resins, carboxyl-functional polyester resins cured with glycidyl-functional acrylic resins, carboxyl-functional acrylic resins cured with polymeric epoxy resins. The curing reaction is preferably induced thermally. In a preferred embodiment, the binder system includes a carboxyl-functional polyester resin and TGIC, such that the resin is cured by reaction with TGIC.

In an embodiment, the polymeric binder of the powder composition is a carboxyl-functional polyester resin, preferably a resin suitable for use in a thermosetting powder composition with epoxide functional compounds. Conventionally, resins with low acid numbers (i.e., less than about 40) are preferred, as these resins produce smooth, glossy coatings with good mechanical characteristics and reduced demand for epoxide-functional curing agents, such as, for example, TGIC. Resins with high acid numbers (i.e., above about 40) require increased levels of curing agents, which traditionally tend to reduce the Tg of the powder coating, leading to greater tendency toward sintering during storage. Surprisingly, the carboxyl-functional polyester resin as described herein has an acid number of preferably at least about 40, more preferably about 45 to 60, and also demonstrates a high Tg for good sintering resistance during storage as seen with low acid number resins, while maintaining excellent smoothness and gloss as well as optimal performance characteristics.

In an embodiment, the carboxyl-functional polyester resin is made in a multistep process, involving reaction of an aromatic diacid, or a mixture of aromatic and aliphatic diacids, with a hydroxy-functional compound, i.e., a diol. In an embodiment, the predominantly used aromatic acid is terephthalic acid, or a mixture of terephthalic acid with other diacids, for a coating with optimal performance characteristics. Without limiting to theory, it is believed that some acids, such as, for example, terephthalic acid, are less soluble in the reaction media, and therefore less suitable for use in a single step process when a carboxyl-functional composition is the desired end product.

Accordingly, in a preferred aspect, the carboxyl-functional polyester resin used in the methods and compositions described herein is a polyester resin derived from a diacid or a mixture of diacids. In an aspect, the polyester resin has an acid number of preferably at least about 40, more preferably about 45 to 60, with molecular weight (Mn) of preferably about 1000 to 10,000, more preferably 1500 to 7,000, and most preferably 2000 to 2600. Suitable diacids include, without limitation, adipic acid, sebacic acid, azelaic acid, phthalic acid, phthalic anhydride, isophthalic acid, terephthalic acid, dimethyl terephthalate, benzophenone dicarboxylic acid, diphenic acid, 4,4-dicarboxydiphenyl ether, 2,5-pyridine dicarboxylic acid, 2,6-naphthalenedicarboxylic acid, 4-hydroxybenzoic acid, trimellitic acid, trimellitic anhydride, and derivatives or combinations thereof.

In an embodiment, the polyester resin is derived from at least about 50 mole %, preferably 70 to 80 mole %, terephthalic acid, less than about 10 mole %, preferably no more than about 5 mole %, aliphatic dicarboxylic acid; and less than about 40 mole %, preferably about 20 to about 30 mole %, isophthalic acid. The polyester resin can be derived from a mixture of diacids that does not include any aliphatic diacid.

In an embodiment, the powder composition described herein is a thermosetting composition including a polymeric binder and a curing agent or crosslinker. In an aspect, curing agents include compounds that can be used as crosslinkers for acid-functional or carboxyl-terminated polyester resins. Curing agents or crosslinkers of this type include, without limitation, epoxy-functional compounds, amides, substituted alkyl amides, bisamides, and the like. In a preferred aspect, the curing agent or crosslinking compound is an epoxide-functional compound. Typical epoxide-functional curing agents are polyepoxide compounds with epoxy equivalent weight of preferably at least about 10, more preferably 50 to 500, and most preferably about 80 to 300. In an aspect, the curing agent is selected to have preferably 0.1 to 5, more preferably 0.5 to 1.5, and most preferably 0.8 to 1.2 epoxy groups per equivalent carboxyl groups in the carboxyl-functional polyester resin. Epoxy-functional curing agents include, without limitation, triglycidyl isocyanurate (TGIC), triglycidyl trimellitate, diglycidyl terephthalate, diglycidyl isophthalate, glycidyl-functional acrylic resins, and the like.

In a preferred embodiment, the polymeric binder of the powder composition includes TGIC as an epoxy-functional curing agent or crosslinker. TGIC, a triazine compound with reactive epoxy functional groups, is known in the art as a curing agent for acid-functional resins, such as acrylic resins, polyester resins, and the like, for example. These TGIC-reactive resins are known to have high hardness, and good chemical resistance. Powder compositions typically have TGIC content in the range of about 3 to 9 wt %, based on the total weight of the resin and crosslinker.

Conventionally, polyesters resins cured with TGIC are designed to have acid numbers on the order of about 35, in order to reduce the amount of TGIC needed in a formulation. Without limiting to theory, because TGIC tends to plasticize the coating composition, higher quantities of TGIC have not been traditionally favored in the art. Moreover, TGIC is also known to reduce the Tg of the polyester-TGIC blend, and therefore, the blend typically includes high Tg polyester resin in order to provide adequate storage resistance against sintering. In general, in order to provide optimal flow and leveling, it is necessary to achieve as low a melt viscosity as possible. However, the high Tg of the polyester needed to maintain sintering resistance during storage limits the melt viscosity that can be achieved.

Conventionally, powder coating compositions therefore typically include low amounts of TGIC (i.e., less than about 10 wt-%) with resins having low acid numbers and relatively low resin Tg if good flow and leveling are needed.

Surprisingly, and in contravention of standard practice and conventional knowledge in the art, the compositions described herein include preferably at least about 10 wt %, more preferably 10 to 15 wt % TGIC, based on the total weight of the resin and crosslinker, with resins having high acid numbers (i.e., at least about 40 or higher) and high resin Tg (i.e., at least about 50° C. or higher). Moreover, the composition described herein demonstrates low melt viscosity and optimal leveling and flow.

In an embodiment, the powder composition described herein includes one or more pigments. Pigments, also termed fillers herein, are included in powder coating compositions to provide specific aesthetic requirements, including for example, color, hide, gloss, and the like. Suitable pigments include, without limitation, various organic or inorganic coloring pigments known in the art, such as, for example, titanium dioxide (TiO₂), calcium carbonate (CaCO₃), carbon black, red iron oxide, yellow iron oxide, raw umber, phthalocyanine blue, phthalocyanine green, naphthol red, toluidine red, various organic yellows, carbazole violet, and quinacridones. If desired, processed coloring pigments, such as pigments that have been coated with polymeric materials may be used.

Conventionally, pigments have not been included in powder coating compositions at higher pigment loading than about 40 wt % based on the total weight of the composition. Increasing the amount of pigment in the composition increases the melt viscosity of the composition, with a corresponding decrease in flow and leveling. As a result, powder compositions with more than about 40 wt % pigment demonstrate poor aesthetic appearance and physical properties, i.e. orange peel, poor gloss, poor smoothness, and the like, and therefore, high pigment loading is not preferred.

Surprisingly, the compositions described herein have pigment loading of at least about 40 wt %, preferably 40 to 50 wt %, more preferably 50 to 60 wt %, based on the total weight of the composition. Contrary to expectations in the industry, the high pigment loading in the compositions does not detract from proper flow and leveling, and the cured coating has optimal physical properties and appearance.

In an embodiment, the composition described herein optionally includes at least one pigment dispersant. As used herein, the term “pigment dispersant” refers to an additive or mixture of additives that can increase the stability of a composition in another medium, such as, for example, a pigment in a powder composition. Suitable examples of dispersants include, for example, compounds with phosphinic acid or ester groups, compounds with sulfonic acid groups, polyesters, acrylates, urethanes, and the like. The dispersant is included in small amounts, preferably at least 0.1 wt % to about 5 wt %, more preferably about 0.1 wt % to 2 wt %, based on the total weight of the composition.

Without limiting to theory, it is believed that the pigment dispersant helps stabilize the pigment when added to the powder composition. The addition of the pigment dispersant allows compositions with higher pigment loading (i.e. greater than 40 wt-%) to be made while retaining good flow and leveling characteristics. Conventionally, powder coatings derived from compositions with higher pigment loading demonstrate poor flow, reduced gloss, poor impact resistance and undesirable amounts of haze, even when a pigment dispersant is included. Surprisingly, the compositions described herein produce powder coatings with optimal flow, gloss and impact resistance, even at high pigment loading. Without limiting to theory, it is believed that the reduced melt viscosity provided by the resin of the invention allows the coating to achieve good melt flow, even at increased pigment loadings.

The powder composition described herein may include other additives. These other additives can improve the application of the powder coating, the melting and/or curing of that coating, or the performance or appearance of the final coating. Examples of optional additives which may be useful in the powder include: cure catalysts, impact modifiers, antioxidants, color stabilizers, slip and mar additives, UV absorbers, hindered amine light stabilizers, conductivity additives, tribocharging additives, anti-corrosion additives, fillers, texture agents, degassing additives, flow control agents, thixotropes, and edge coverage additives.

Powder coatings are generally manufactured in a multi-step process. Various ingredients are dry-blended to form a premix. Accordingly, in an embodiment, the powder coating composition is made as described herein. The polymeric binder (i.e. carboxyl-functional polyester resin and TGIC curing agent) is dry mixed together with one or more pigments and a pigment dispersant to form a premix. The premix is then melt blended in an extruder by a combination of heat, pressure and shear. The resulting extrudate is cooled to form a friable solid, and then ground or pulverized to form a powder. Depending on the desired coating end use, the grinding conditions are typically adjusted to achieve a powder median particle size of about 25 to 150 microns.

Other methods of making a powder coating composition may also be used. For example, one alternative method uses liquid carbon dioxide. In that method, the dry ingredients (i.e. the polyester resin, the TGIC curing agent, the one or more pigments and the pigment dispersant) are mixed into the liquid carbon dioxide and then sprayed to form the powder particles. If desired, powders may be classified or sieved to achieve a desired particle size and/or distribution of particle sizes.

The resulting powder is at a size that can effectively be used by the application process. Practically, particles less than 10 microns in size are difficult to apply effectively using conventional electrostatic spraying methods. Consequently, powders having median particle size less than about 25 microns are difficult to electrostatic spray because those powders typically have a large fraction of small particles. Preferably the grinding is adjusted (or sieving or classifying is performed) to achieve a powder median particle size of about 25 to 150 microns, more preferably 30 to 70 microns, most preferably 30 to 50 microns.

Optionally, other additives may be used in the present invention. As discussed above, these optional additives may be added prior to extrusion and be part of the premix, or may be added after extrusion. Suitable additives for addition after extrusion include materials that would not perform well if they were added prior to extrusion, materials that would cause additional wear on the extrusion equipment, or other additives.

Additionally, optional additives include materials which are feasible to add during the extrusion process, but may also be added later. The additives may be added alone or in combination with other additives to provide a desired effect on the powder finish or the powder composition. These other additives can improve the application of the powder, the melting and/or curing, or the final performance or appearance. Examples of optional additives which may be useful include: cure catalysts, antioxidants, color stabilizers, slip and mar additives, conductivity additives, tribocharging additives, anti-corrosion additives, fillers, texture agents, degassing additives, flow control agents, thixotropes, and edge coverage additives.

Other preferred additives include performance additives such as rubberizers, friction reducers, and microcapsules. Additionally, the additive could be an abrasive, a heat sensitive catalyst, an agent that helps create a porous final coating, or that improves wetting of the powder.

Techniques for preparing powder compositions are known to those of skill in the art. Mixing can be carried out by any available mechanical mixer or by manual mixing. Some examples of possible mixers include Henschel mixers (available, for example, from Henschel Mixing Technology, Green Bay, Wis.), Mixaco mixers (available from, for example, Triad Sales, Greer, S.C. or Dr. Herfeld GmbH, Neuenrade, Germany), Marion mixers (available from, for example, Marion Mixers, Inc., 3575 3rd Avenue, Marion, Iowa), invertible mixers, Littleford mixers (from Littleford Day, Inc.), horizontal shaft mixers and ball mills. Preferred mixers would include those that are most easily cleaned.

The final powder may then be applied to an article by various means including the use of fluid beds and spray applicators. Most commonly, an electrostatic spraying process is used, wherein the particles are electrostatically charged and sprayed onto an article that has been grounded so that the powder particles are attracted to and cling to the article. After coating, the article is heated. This heating step causes the powder particles to melt and flow together to coat the article. Optionally, continued or additional heating may be used to cure the coating.

The coating is optionally cured, and such curing may occur via continued heating, subsequent heating, or residual heat in the substrate. In an embodiment, a powder composition applied to a substrate is heated or baked by conventional methods, to a temperature of approximately about 204° C. (400° F.) for about 15 minutes. Under these conditions, the coating is fully cured, i.e., sufficient crosslinking occurs to provide a cured coating with optimal mechanical properties and surface smoothness.

The compositions and methods described herein may be used with a wide variety of substrates. Typically and preferably, the powder coating compositions described herein are used to coat metal substrates, including without limitation, unprimed metal, clean-blasted metal, and pretreated metal, including plated substrates, ecoat-treated metal substrates, and substrates that are the same color as the powder coating composition. Typical pretreatments for metal substrates include, for example, treatment with iron phosphate, zinc phosphate, and the like. Metal substrates can be cleaned and pretreated using a variety of standard processes known in the industry. Examples include, without limitation, iron phosphating, zinc phosphating, nanoceramic treatments, various ambient temperature pretreatments, zirconium containing pretreatments, acid pickling, or any other method known in the art to yield a clean, contaminant-free surface on a substrate.

The coating compositions and methods described herein are not limited to conversion coatings, i.e., parts or surfaces treated with conversion coatings. Moreover, the coating compositions described herein may be applied to substrates previously coated by various processes known to persons of skill in the art, including for example, ecoat methods, plating methods, and the like. There is no expectation that substrates to be coated with the compositions described herein will always be bare or unprimed metal substrates.

Preferably, the coated substrate has desirable physical and mechanical properties. Typically, the final film coating will have a thickness of 25 to 200 microns, preferably 50 to 150 microns, more preferably 50 to 75 microns.

### EXAMPLES

Unless indicated otherwise, the following test methods were utilized in the Example(s) that follow(s).

### PCI Smoothness

The smoothness of cured coatings made from the powder compositions is determined using visual standards developed by the Powder Coating Institute. Under this standard, a visual scale of ten powder-coated panels, graded from 1 (high roughness/orange peel) to 10 (very smooth, high gloss finish) is used. To determine relative smoothness, a powder-coated sample is visually compared with the standard panels, and a smoothness grade is assigned by judging which standard panel is closest to the sample.

### Impact Resistance

The direct and reverse impact resistance of cured coatings prepared from the powder compositions is tested using the method described in ASTM D2794 (Standard Test Method for Resistance of Organic Coatings to the Effects of Rapid Deformation).

### Flexibility

The flexibility of cured coatings prepared from the powder compositions is tested using the Mandrel Bend Test, as described in ASTM D522 (Standard Test Methods for Mandrel Bend Test for Attached Organic Coatings).

### Solvent Resistance

The solvent resistance of cured coatings prepared from the powder compositions is tested using the method described in ASTM D4752 (Standard Test Methods for Measuring MEK Resistance). The results are rated visually on a scale of 1 to 5, where 1 represents complete failure (i.e., the solvent penetrates down to the substrate after 100 double rubs) and 5 represents no effect (i.e., the solvent produces no visually detectable effect on the coating after 100 double rubs).

### Powder Tg

A sample of the finished powder is placed in a differential scanning calorimeter (Perkin Elmer Model DSC-7) and pre-conditioned by heating from 30° C. to 70° C. at 20° C./minute, cooled from 70° C. to 30° C. at 200° C./minute, held at 30° C. for 3 minutes, and then scanned from 30° C. to 260° C. at 20° C./minute. The glass transition temperature is taken as the half the change in heat capacity at the inflection point of the final scan.

### Stability Rating

A small sample of finished powder is placed in an oven which is maintained at a temperature of 110° F., and examined after 24 hours. The powder compositions are rated for physical stability on a scale of 1 (small blocks, easy to break into free flowing powder) to 5 (one large block, very difficult to break).

### Gloss

The gloss or surface smoothness of cured coatings prepared from the powder compositions is tested as 20-degree gloss, using the method described in ASTM D523 (Standard Test Method for Specular Gloss).

### Gel Time

The gel time of the finished powder is measured as described in ASTM D4217 (Standard Test Method for Gel Time of Thermosetting Coating Powders), at 200° C.

### Pill Flow

The Pill flow is measured as described in ASTM D4242 (Standard Test Method for Inclined Plate Flow for Thermosetting Coating Powders).

### Melt Viscosity

The melt viscosity of the resin is determined on a Brookfield Model Cap 2000H viscometer set to a temperature of 160° C., and operating at a rotational speed of 300 RPM using a number 06 spindle.

### Example 1

### Preparation of Resin #1

A reaction flask equipped with a mechanical stirrer, fractionating column, nitrogen inlet and a thermocouple probe with a temperature controller was charged with 1434.2 parts by weight of neopentyl glycol, 32.6 parts trimethylolpropane and 0.8 parts aryl phosphite antioxidant. The mixture was heated under a nitrogen blanket until the glycols were melted, then 1973.4 parts by weight of terephthalic acid and 8 parts by weight of a tin-based esterification catalyst were added with agitation. Heating was continued until a temperature of 185° C. was reached. Thereafter, the temperature was increased 5° C. every 30 minutes, up to a maximum of 230° C. The progress of the esterification reaction was monitored by measuring the volume of distillate water. When the first stage of the reaction turned clear and the overhead distillation temperature began to drop, the fractionating column was removed and vacuum (−5″ Hg to −7″ Hg) was applied. After the first stage acid number dropped below 7, the resin was cooled to 200° C. and the second stage acids, i.e. 39.5 parts by weight of adipic acid and 56.7 parts by weight of isophthalic acid, were added. The temperature was gradually increased to a maximum of 235° C. over the next two hours. Once the distillate rate slowed sufficiently to allow the distillate temperature to drop, vacuum (−5″ Hg) was applied. Vacuum was increased gradually over the next two hours, and then held at −25″ Hg for two hours until a final acid number of 53.9 was obtained. The resin was discharged to a pan and allowed to cool to room temperature. A final melt viscosity of 218 Poise at 160° C. was observed.

### Example 2

### Preparation of Resin #2

A resin was prepared as described in Example 1 above, except that the adipic acid was added in the first stage along with terephthalic acid. The finished resin had an acid number of 52.2 and a melt viscosity of 271 Poise at 160° C.

### Example 3

### Comparative Example

For purposes of comparison, commercially available polyester resin manufactured and sold for use in TGIC-cured powder coating compositions is used. The commercial resin has acid number of about 32 to 38 and a melt viscosity of about 350 to 550 poise at 160° C.

### Examples 4 to 6

### Preparation of Powder Coating Formulation

Powder coating formulations were made by premixing Resin (from Example 2) along with other ingredients in the amounts shown in Table 1 below, with the exception that the fumed silica was added at the final grinding step. The premix was extruded on an extruder (Werner-Pfleiderrer ZSK-30) at 300 RPM and temperature set points of 70° C. (zone 1) and 120° C. (zone 2). The extruded solid was then treated with the fumed silica as shown in the table, and milled using a Brinkman grinder with 0.5 mm screen, then sieved at 140 mesh. The powder compositions were sprayed on to test panels by standard electrostatic spray methods and cured by heating for 15 minutes at 204° C. The powders and panels were evaluated for various physical properties, and results are shown in Table 4.

TABLE 1
Preparation of Powder Coating Formulations

| Example | Ex. 4 | Ex. 5 | Ex. 6 |
|---|---|---|---|
| Resin (Example 2) | 540.0 | 450.0 | 360.0 |
| TGIC | 60.0 | 50.0 | 40.0 |
| Acrylate flow control (33% silica | 8.0 | 8.0 | 8.0 |
| carrier) | | | |
| Benzoin | 3.0 | 3.0 | 3.0 |
| Titanium dioxide | 225.0 | 225.0 | 225.0 |
| Iron oxide yellow | 3.0 | 3.0 | 3.0 |
| Iron oxide red | 0.2 | 0.2 | 0.2 |
| Carbon black | 0.2 | 0.2 | 0.2 |
| Calcium carbonate | 160.6 | 260.6 | 360.6 |
| Fumed silica | 2.0 | 2.0 | 2.0 |
| Total | 1002.0 | 1002.0 | 1002.0 |
| Pigment loading (wt % of total) | 39.3% | 49.3% | 59.2% |

### Examples 7 and 8

### Comparative Examples

Powder coating formulations were prepared according to the method described in Example 4, using the commercially available resin described in Example 3, and other ingredients as shown in Table 2 below. Test panels with the formulations applied and cured thereon are evaluated for various physical properties, and results are shown in Table 4.

TABLE 2
Preparation of Powder Coating Formulations

| Example | Ex. 7 | Ex. 8 |
|---|---|---|
| Resin (Example 3) | 540.0 | 450.0 |
| TGIC | 60.0 | 50.0 |
| Acrylate flow control (33% silica carrier) | 8.0 | 8.0 |
| Benzoin | 3.0 | 3.0 |
| Titanium dioxide | 225.0 | 225.0 |
| Iron oxide yellow | 3.0 | 3.0 |
| Iron oxide red | 0.2 | 0.2 |
| Carbon black | 0.2 | 0.2 |
| Calcium carbonate | 160.6 | 260.6 |
| Fumed silica | 2.0 | 2.0 |
| Total | 1002.0 | 1002.0 |
| Pigment loading (wt % of total) | 39.3% | 49.3% |

### Examples 9 to 11

Powder coating formulations are prepared according to the method described in Example 4, using the experimental resin described in Example 1 (for Examples 9 and 10), or the commercially available resin described in Example 3 (for Example 11). Other ingredients are included as shown in Table 3 below. Test panels with formulations applied and cured thereon are evaluated for various physical properties, and results are shown in Table 4.

TABLE 3
Preparation of Powder Coating Formulations

| Example | Ex. 9 | Ex. 10 | Ex. 11 |
|---|---|---|---|
| Resin (Ex. 1) | 450.0 | 450.0 | — |
| Resin (Ex. 3) | — | — | 450.0 |
| TGIC | 50.0 | 50.0 | 50.0 |
| Acrylate flow control | 8.0 | 8.0 | 8.0 |
| Benzoin | 3.0 | 3.0 | 3.0 |
| Titanium dioxide | 225.0 | 225.0 | 225.0 |
| Iron oxide yellow | 3.0 | 3.0 | 3.0 |
| Iron oxide red | 0.2 | 0.2 | 0.2 |
| Carbon black | 0.2 | 0.2 | 0.2 |
| Calcium carbonate | 260.6 | 250.6 | 250.6 |
| Pigment dispersant (Byk 3950P) | — | 10.0 | 10.0 |
| Fumed silica | 2.0 | 2.0 | 2.0 |
| Total | 1002.0 | 1002.0 | 1002.0 |
| Pigment loading (wt % of total) | 49.3% | 48.3% | 48.3% |

TABLE 4
Comparison Physical Properties of Powder Coatings

| Property | Ex. 4 | Ex. 5 | Ex. 6 | Ex. 7 | Ex. 8 | Ex. 9 | Ex. 10 | Ex. 11 |
|---|---|---|---|---|---|---|---|---|
| Pigment loading (%) | 39.3 | 49.3 | 59.2 | 39.3 | 49.3 | 49.3 | 48.3 | 48.3 |
| Pigment dispersant (%) | 0% | 0% | 0% | 0% | 0% | 0% | 1% | 1% |
| Gel time (200° C.- seconds) | 98 | 93 | 88 | 138 | 148 | 89 | 94 | 150 |
| Pill flow (mm) | 44 | 31 | 19 | 45 | 31 | 34 | 41 | 38 |
| Impact (Dir/Rev: in-lbs) | 80/160 | 60/100 | 40/40 | 60/40 | 40/60 | 80/10 | 80/10 | 40/20 |
| Mandrel Bend (in-radius) | ⅛″ | ⅛″ | ⅛″ | ⅛″ | ⅛″ | ⅛″ | ⅛″ | ⅛″ |
| MEK resistance | 4 | 4 | 4 | 1 | 1 | 4 | 4 | 1 |
| Gloss (60°/20°) | 75/38 | 66/24 | 62/18 | 71/28 | 60/18 | 63/19 | 64/22 | 60/17 |
| PCI smoothness rating | 5-6 | 4-5 | 3 | 4 | 3 | 4 | 5 | 3 |
| Powder Tg (° C.) | 50.7 | 48.1 | 51.4 | 54.0 | 52.8 | 50.4 | 43.6 | 47.6 |
| Stability Rating | 3-4 | 3-4 | 3-4 | 5 | 5 | 3-4 | 2-3 | 5 |

From the data in Table 4 above, several conclusions can be drawn. First, the resins of the invention (Examples 1 and 2) produced significantly improved MEK resistance compared to the comparative commercial resin (Example 3). Additionally, compositions based on Resin Examples 1 and 2, despite having shorter gel times, produced films having improved smoothness ratings when compared to counterparts based on Comparative Example 3. Addition of the pigment dispersant also provided an improvement in smoothness, although it also reduced the powder Tg and sintering resistance.

The complete disclosure of all patents, patent applications, and publications, and electronically available material cited herein are incorporated by reference. The foregoing detailed description and examples have been given for clarity of understanding only. No unnecessary limitations are to be understood therefrom. The invention is not limited to the exact details shown and described, for variations obvious to one skilled in the art will be included within the invention defined by the claims. The invention illustratively disclosed herein suitably may be practiced, in some embodiments, in the absence of any element which is not specifically disclosed herein.

What is claimed is:

1. A powder coating composition, comprising:
a solid carboxyl-functional polyester resin having an acid number of about 45 to 60 and a melt viscosity of less than about 300 poise at 160° C.;
a triglycidyl isocyanurate (TGIC) curing agent;
one or more pigments at a total pigment loading of at least about 40 wt %, based on the total weight of the composition; and
optionally, a pigment dispersant,
wherein the powder coating composition has Tg of at least about 42° C.

2. A method of making a powder coating composition, comprising:
providing a carboxyl-functional polyester resin having an acid number of about 45 to 60 and a melt viscosity of less than about 300 poise at 160° C.;
providing a TGIC curing agent;
providing one or more pigments at a total pigment loading of at least about 40 wt %, based on the total weight of the composition;
providing a pigment dispersant;
blending the carboxyl-functional polyester resin, the curing agent, one or more pigments, and the pigment dispersant to form a premix;
extruding the premix to obtain a solid composition; and
grinding to obtain a powder coating composition.

3. The composition of claim 1, wherein the carboxyl-functional polyester resin has an acid number of about 50 to 55.

4. The composition of claim 1, wherein the carboxyl-functional polyester resin has Tg of at least about 65° C.

5. The composition of claim 1, wherein the carboxyl-functional polyester resin has Tg of about 70° C.

6. The composition of claim 1, wherein the carboxyl-functional polyester resin is present in amount of about 80 to 90 weight percent, based on the total weight of the binder.

7. The composition of claim 1, wherein the total pigment load is about 50 wt % to about 80 wt %, based on the total weight of the composition.

8. The composition of claim 1, wherein the carboxyl-functional polyester resin is derived from a mixture of dicarboxylic acids.

9. The composition of claim 1, wherein the carboxyl-functional polyester resin is derived from one or more dicarboxylic acids selected from adipic acid, sebacic acid, azelaic acid, phthalic acid, phthalic anhydride, isophthalic acid, terephthalic acid, dimethyl terephthalate, benzophenone dicarboxylic acid, diphenic acid, 4,4-dicarboxydiphenyl ether, 2,5-pyridine dicarboxylic acid, 2,6-naphthalenedicarboxylic acid, 4-hydroxybenzoic acid, trimellitic acid, trimellitic anhydride, and combinations thereof.

10. The composition of claim 1, wherein the carboxyl-functional polyester resin is derived from a mixture of dicarboxylic acids comprising:
at least about 50 mole % terephthalic acid;
less than about 10 mole % aliphatic dicarboxylic acid; and
less than about 40 mole % isophthalic acid.

11. The composition of claim 1, wherein the TGIC curing agent is present in an amount of about 10 to 15 weight percent, based on the total weight of the composition.

12. The composition of claim 1, wherein the pigment dispersant is selected from polyester, acrylate, urethane, and mixtures thereof.

13. The composition of claim 1, wherein the pigment dispersant is present in an amount of about 0.1 to 5 wt %, based on the total weight of the composition.

14. A method of coating an article, comprising:
providing an article;
applying on at least one surface of the article the coating composition of claim 1; and
heating the substrate for about 10 to 15 minutes at a temperature of 190 to 220° C. to form a cured coating on the article.

15. A coated article, comprising a substrate having disposed thereon a cured coating formed from the composition of claim 1.
